(19) United States
(12) Patent Application Publication
(10) Pub. No.: US 2021/0286499 A1
(43) Pub. Date: Sep. 16, 2021

(54) TOUCH POSITION DETECTION SYSTEM

(71) Applicant: DENSO CORPORATION, Kariya-city (JP)

(72) Inventor: Hiromasa OBUTA, Kariya-city (JP)

(21) Appl. No.: 17/336,704

(22) Filed: Jun. 2, 2021

Related U.S. Application Data
(63) Continuation of application No. PCT/JP2020/010548, filed on Mar. 11, 2020.

(30) Foreign Application Priority Data
Mar. 26, 2019 (JP) 2019-058502

(51) Int. Cl. G06F 3/041

(52) U.S. Cl. CPC G06F 3/04186; G06F 2203/04104; G06F 3/0414

(57) ABSTRACT

In a touch position detection system, a counted number of a touched position by a touch operation on a touch panel is detected as a touch count, and a coordinate of the touched position by the touch operation on the touch panel is detected as a touch coordinate. Based on the touch count and the touch coordinate, a displayed screen image on a display screen is controlled. In response to determining a one-point touch operation that is the touch operation touching one position on the touch panel, an operability-oriented process is performed. In response to determining a plurality-of-points touch operation that is the touch operation touching a plurality of positions on the touch panel, an accuracy-oriented process is performed.

### CROSS REFERENCE TO RELATED APPLICATIONS

The present application is a continuation application of International Patent Application No. PCT/JP2020/010548 filed on Mar. 11, 2020, which designated the U.S. and claims the benefit of priority from Japanese Patent Application No. 2019-058502 filed on Mar. 26, 2019. The entire disclosures of all of the above applications are incorporated herein by reference.

### TECHNICAL FIELD

The present disclosure relates to a touch position detection system.

### BACKGROUND

For example, a navigation device mounted on a vehicle is provided with a touch panel as an HMI (Human Machine Interface). The touch panel is classified into a capacitance type, a resistance film type, and the like according to a method of detecting a touch operation. In recent years, for example, navigation devices have been required to have the same operability as mobile terminals such as smartphones. There is disclosed a configuration of a resistive touch panel having a multi-touch function for detecting a touch operation touching a plurality of positions simultaneously.

### SUMMARY

According to an example of the present disclosure, a touch position detection system is provided as follows. A counted number of a touched position by a touch operation on a touch panel is detected as a touch count, and a coordinate of the touched position by the touch operation on the touch panel is detected as a touch coordinate. Based on the touch count and the touch coordinate, a displayed screen image on a display screen is controlled. In response to determining a one-point touch operation that is the touch operation touching one position on the touch panel, an operability-oriented process is performed. In response to determining a plurality-of-points touch operation that is the touch operation touching a plurality of positions on the touch panel, an accuracy-oriented process is performed.

### BRIEF DESCRIPTION OF DRAWINGS

The objects, features, and advantages of the present disclosure will become more apparent from the following detailed description made with reference to the accompanying drawings. In the drawings:

FIG. 1 is a diagram showing an overall configuration according to a first embodiment of the present disclosure;

FIG. 2 is a diagram schematically showing an upper layer and a lower layer;

FIG. 3 is a flowchart;

FIG. 4 is a flowchart showing a second embodiment;

FIG. 5 is a diagram showing an overall configuration according to a third embodiment; and

FIG. 6 is a diagram schematically showing an upper layer, a lower layer, and a piezoelectric element layer.

### DETAILED DESCRIPTION

### First Embodiment

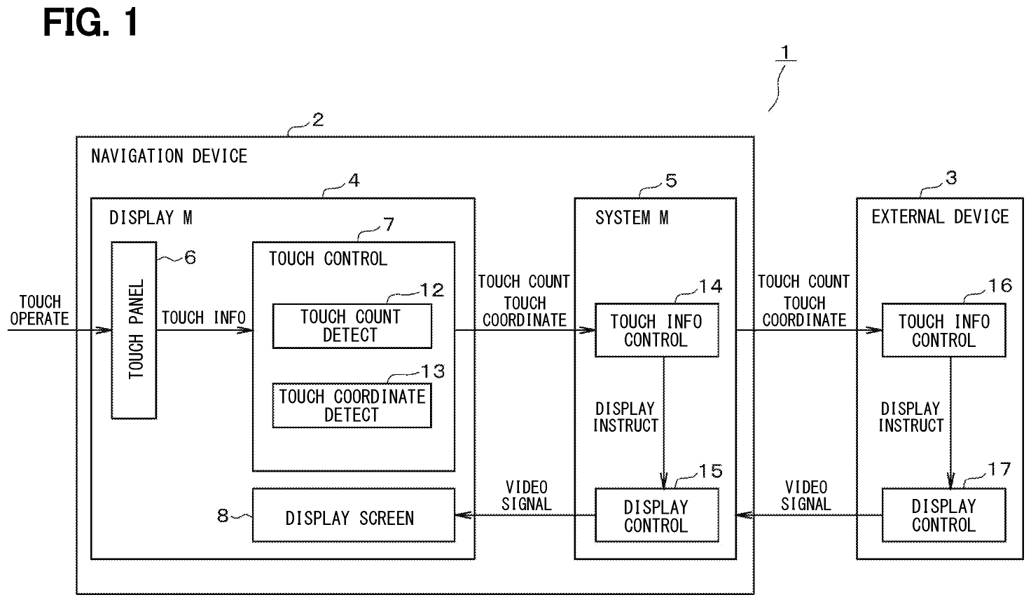

A first embodiment will be described with reference to FIGS. 1 to 3. A touch operation performed by a user on a touch panel includes a one-point touch operation and a two-point touch operation. The one-point touch operation, which touches one position on the touch panel 6, includes a tap to tap the touch panel once with a fingertip, a long press to press and hold the touch panel with a fingertip, a flick to touch and flick the touch panel with a fingertip, and a swipe to touch and slide the touch panel with a fingertip. The two-point touch operation, which touches two positions on the touch panel 6, is included in a plurality-of-points touch operation (i.e., a several-point touch operation) that touches a plurality of positions (i.e., several positions) on the touch panel 6. The two-point touch operation includes a pinch-in to touch the touch panel with two fingertips and narrow the distance between the two fingertips, and a pinch-out to touch the touch panel with two fingertips and widen the distance between the two fingertips.

As shown in FIG. 1, the touch position detection system 1 includes (i) a navigation device 2 mounted on a vehicle and (ii) an external device 3; the navigation device 2 communicates with the external device 3. The external device 3 is, for example, a mobile terminal such as a smartphone or tablet that can be carried by a user. The navigation device 2 and the external device 3 perform data communication by, for example, a data communication method compliant with a communication standard of USB (Universal Serial Bus) or Bluetooth (registered trademark). That is, the user brings the external device 3 into the vehicle interior; the external device 3 is communicably connected to the navigation device 2 so as to be capable of data communication. For example, when the map application installed in the external device 3 is started, the map data is transferred from the external device 3 to the navigation device 2, to allow the map screen to be displayed in the navigation device 2. The user can receive the service of the map application installed in the external device 3 by touching the touch panel in the navigation device 2 to operate the map screen.

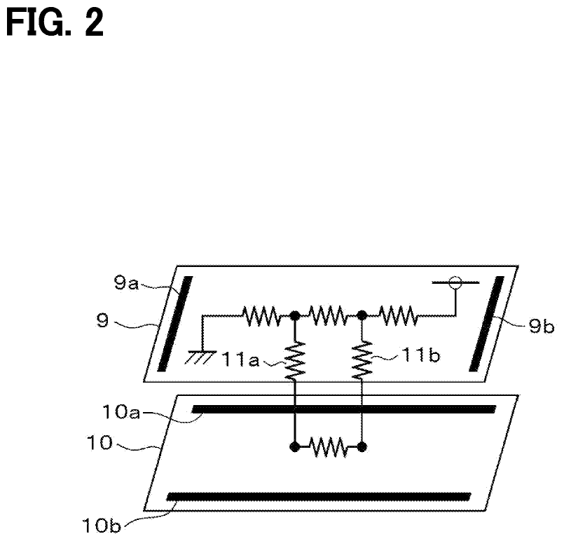

The navigation device 2 includes a display module 4 (which may also be referred to as a display unit 4) and a system module 5 (which may also be referred to as a system unit 5). The display module 4 includes (i) a touch panel 6 that can be touch-operated by the user, (ii) a touch controller 7 (which may also be referred to as a touch controller unit 7), and (iii) a display screen 8. As shown in FIG. 2, the touch panel 6 includes an upper layer 9 and a lower layer 10. The upper layer 9 is a layer that is touch-operated by a finger, a pen, or the like, and is made of, for example, polyethylene terephthalate (PET) or the like. A plurality of first electrodes 9a and 9b arranged in a first direction are formed in the upper layer 9. The first electrodes 9a and 9b are composed of a transparent conductive substance such as indium tin oxide (ITO (Indium Tin Oxide)) and indium zinc oxide (IZO (Indium Zinc Oxide)). The lower layer 10 is made of, for example, glass, plastic, polyethylene terephthalate, or the like. A plurality of second electrodes 10a and 10b arranged in a second direction orthogonal to the first direction are formed in the lower layer 10. Like the first electrodes 9a and 9b, the second electrodes 10a and 10b are made of a transparent conductive material such as indium tin oxide and indium zinc oxide.

The upper layer 9 and the lower layer 10 are bonded by an adhesive in a non-touch region where the first electrodes 9a and 9b and the second electrodes 10a and 10b are not formed. That is, the separation distance between the upper layer 9 and the lower layer 10 is set by the height of the adhesive. A spacer made of an insulating resin such as epoxy or acrylic resin is arranged between the upper layer 9 and the lower layer 10. A predetermined gap is maintained between the first electrodes 9a and 9b and the second electrodes 10a and 10b by the spacer. When the upper layer 9 of the touch panel 6 is touch-operated by, for example, a fingertip or a pen, the first electrodes 9a and 9b and the second electrodes 10a and 10b come into contact with each other. Thereby, the resistance values of the resistors 11a and 11b between the upper layer 9 and the lower layer 10 change, to change the voltage. The change in voltage is output to the touch controller 7 as touch information.

The touch controller 7 includes a touch count detector 12 (which may also be referred to as a touch count detector unit 12) and a touch coordinate detector 13 (which may also be referred to as a touch coordinate detector unit 13). When the touch information is input (i.e., received) from the touch panel 6, the touch count detector 12 detects the counted number of points (i.e., positions) touched on the touch panel 6 as touch count based on the inputted touch information. The detected touch count is output to the system module 5. When the touch information is input (i.e., received) from the touch panel 6, the touch coordinate detector 13 detects the coordinate of a touched point that is a point (i.e., position) touched on the touch panel 6 as a touch coordinate, and outputs the detected touch coordinate to the system module 5.

The touch coordinate detector 13 selectively performs either an operability-oriented process or an accuracy-oriented process. The touch coordinate detector 13 may determine that the touch operation touching one point (i.e., one-point touch operation) from the detection result of the touch count detector 12. In this case, the touch coordinate detector 13 acquires the coordinate of the one point and uses the acquired coordinate of the one point to perform the operability-oriented process. The touch coordinate detector 13 performs, as an operability-oriented process, a process of relatively shortening the update time of the touch coordinate without excluding the unstable coordinate immediately after the touch operation from the detection target. On the other hand, the touch coordinate detector 13 may determine that the touch operation touching two points (i.e., two-point touch operation) from the detection result of the touch count detector 12. In this case, the touch coordinate detector 13 acquires the coordinates of the two points and applies the accuracy-oriented process to the acquired coordinates of the two points. The touch coordinate detector 13 performs, as an accuracy-oriented process, a process of excluding the unstable coordinate immediately after the touch operation from the detection target and relatively lengthening the update time of the touch coordinate.

The system module 5 includes (i) a touch information controller 14 (which may also be referred to as a touch information controller unit 14) and (ii) a display controller 15 (which may also be referred to as a display controller unit 15). The touch information controller 14 receives the touch count and touch coordinate from the touch controller 7 in a state where the external device 3 is not connected to the navigation device 2. In this case, the touch information controller 14 controls the touch information according to the received touch count and the touch coordinates. The touch information controller 14 selectively performs either the operability-oriented process or the accuracy-oriented process.

When the touch information controller 14 determines that the touch operation touching one point (i.e., one-point touch operation), the touch information controller 14 acquires the coordinate of the one point and uses the acquired coordinate of the one point to perform the operability-oriented process. The touch information controller 14 performs, as the operability-oriented process, a process of relatively decreasing the counted number of moving average steps up to the time when the touch coordinate is output by releasing the filter. On the other hand, when the touch information controller 14 determines that the touch operation touching two points (i.e., two-point touch operation), the touch information controller 14 acquires the coordinates of the two points and performs the accuracy-oriented process for each of the acquired coordinates of the two points. The touch information controller 14 performs, as the accuracy-oriented process, a process of performing a process of relatively increasing the counted number of moving average steps up to the time when the touch coordinate is output by setting the filter. When either the operability-oriented process or the accuracy-oriented process is performed as a performed process, the touch information controller 14 outputs a display instruction to the display controller 15 according to the performed process.

On the other hand, when the touch information controller 14 receives the touch count and the touch coordinate from the touch controller 7 while the external device 3 is connected to the navigation device 2, the touch information controller 14 forwards the received touch count and the touch coordinate to the external device 3.

When the display controller 15 receives a display instruction from the touch information controller 14, the display controller 15 outputs a video signal to the display screen 8. When a video signal is received from the display controller 15, the display screen 8 displays a screen image based on the received video signal. When the touch coordinate detector 13 and the touch information controller 14 perform the operability-oriented process, the display screen 8 performs an operability-oriented screen display. When the display screen 8 performs the operability-oriented screen display, the touch coordinate detector 13 and the touch information controller 14 perform the operability-oriented process as described above, so that the screen display (i.e., displayed screen image) immediately follows the touch operation. On the other hand, when the touch coordinate detector 13 and the touch information controller 14 perform the accuracy-oriented process, the display screen 8 performs an accuracy-oriented screen display. When the display screen 8 performs the accuracy-oriented screen display, the touch coordinate detector 13 and the touch information controller 14 perform the accuracy-oriented process as described above, so that the touched position is accurately detected.

The external device 3 includes (i) a touch information controller 16 (which may also be referred to as a touch information controller unit 16) and (ii) a display controller 17 (which may also be referred to as a display controller unit 17), similarly to the system module 5. When the touch count and the touch coordinate are transferred to the touch information controller 16 from the navigation device 2 while the external device 3 is connected to the navigation device 2, the touch information controller 16 controls the touch information according to the transferred touch count and touch coordinate. Like the touch information controller 14, the touch information controller 16 selectively performs either the operability-oriented process or the accuracy-oriented process.

When the touch information controller 16 determines that the touch operation touching one point (i.e., one-point touch operation), the touch information controller 16 acquires the coordinate of the one point, and uses the acquired coordinate of the one point to perform the operability-oriented process. The touch information controller 16 performs, as the operability-oriented process, a process of relatively decreasing the counted number of moving average steps up to the time when the touch coordinate is output by releasing the filter. On the other hand, when the touch information controller 16 determines that the touch operation touching two points (i.e., two-point touch operation), the touch information controller 16 acquires the coordinates of the two points and performs the accuracy-oriented process for each of the acquired coordinates of the two points. The touch information controller 16 performs, as the accuracy-oriented process, a process of relatively increasing the counted number of moving average steps up to the time when the touch coordinate is output by setting the filter. When either the operability-oriented process or the accuracy-oriented process is performed as a performed process, the touch information controller 14 outputs a display instruction to the display controller 17 according to the performed process.

When the display controller 17 receives the display instruction from the touch information controller 16, the display controller 17 transfers the video signal to the display controller 15. When the video signal is transferred from the external device 3, the display controller 15 outputs the transferred video signal to the display screen 8. When the video signal is received from the display controller 15, the display screen 8 displays the screen based on the received video signal. When the touch coordinate detector 13 and the touch information controller 16 perform the operability-oriented process, the display screen 8 performs the operability-oriented screen display. On the other hand, when the touch coordinate detector 13 and the touch information controller 16 perform the accuracy-oriented process, the display screen 8 performs the accuracy-oriented screen display.

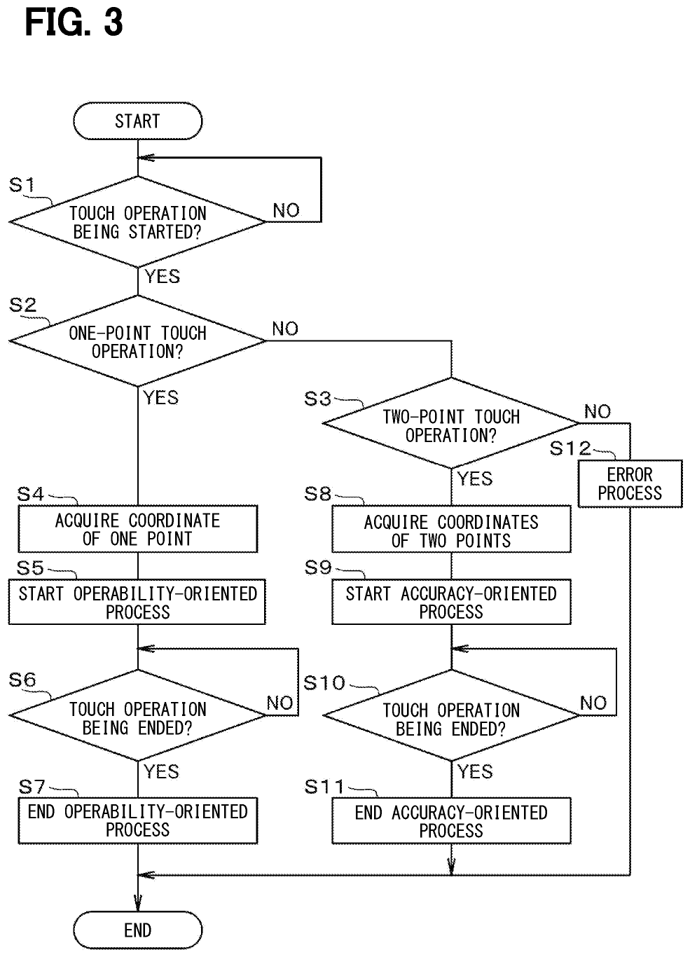

An operation of the configuration described above is explained next with reference to FIG. 3. Here, the case where the external device 3 is communicably connected to the navigation device 2 will be described. The touch position detection system 1 is waiting for a start of a touch operation (S1). The touch position detection system 1 determines the start of the touch operation, for example, when the fingertip touches the touch panel 6 (S1: YES). The touch count detector 12 determines whether it is a one-point touch operation or a two-point touch operation (S2, S3).

When the touch position detection system 1 determines the one-point touch operation (S2: YES), the touch coordinate of the one point is acquired (S4), and the acquired touch coordinate of the one point is used to start to perform the operability-oriented process (S5). That is, in the touch position detection system 1, the touch coordinate detector 13 starts a process of relatively shortening the update time of the touch coordinate without excluding the unstable coordinate immediately after the touch operation from the detection target; and the touch information controller 16 starts a process of relatively decreasing the counted number of moving average steps up to the time when the touch coordinate is output by releasing the filter.

The touch position detection system 1 waits for the end of the touch operation (S6). When, for example, determines the end of the touch operation due to the fingertip moving away from the touch panel 6 (S6: YES), the operability-oriented process is ended (S7). That is, from the start to the end of the touch operation of one point on the touch panel 6, the touch coordinate detector 13 and the touch information controller 16 perform the operability-oriented process. As a result, the screen display with an operability-oriented process (i.e., the operability-oriented screen display) will be performed.

On the other hand, when the touch position detection system 1 determines the two-point touch operation (S3: YES), the touch coordinates of the two points are acquired (S8), and the acquired touch coordinates of the two points are used to start the accuracy-oriented process (S9). That is, in the touch position detection system 1, the touch coordinate detector 13 starts a process of excluding unstable coordinates immediately after the touch operation from the detection target and lengthening the update time of the touch coordinate relatively; and the touch information controller 16 sets a filter and starts a process of relatively increasing the number of moving average stages until the touch coordinate is output. The touch position detection system 1 waits for the end of the touch operation (S10). When, for example, it is determined the end of the touch operation due to the fingertip moving away from the touch panel 6 (S10: YES), the touch position detection system 1 ends the accuracy-oriented process (S11). That is, from the start to the end of the two-point touch operation on the touch panel 6, the touch coordinate detector 13 and the touch information controller 16 perform the accuracy-oriented process to thereby perform the accuracy-oriented screen display.

When it is determined that the touch position detection system 1 is neither the one-point touch operation nor the two-point touch operation (S2: NO, S3: NO), an error process is performed (S12). The above is explained for the case performed by selecting either the operability-oriented process or the accuracy-oriented process in the touch coordinate detector 13 and the touch information controller 16 when the external device 3 is connected to the navigation device 2. However, when the external device 3 is not connected to the navigation device 2, the touch coordinate detector 13 and the touch information controller 14 may select either the operability-oriented process or the accuracy-oriented process.

The first embodiment as described above produces the following operational effects. In the touch position detection system 1, when it is determined that a touch operation is made at one point (i.e., when the one-point touch operation is determined), the touch coordinate detector 13 and the touch information controllers 14 and 16 perform the operability-oriented process. Thus, operability can be prioritized over accuracy, and operability during touch operation can be improved. When it is determined that the touch operation is made at two points (i.e., when the two-point touch operation is determined), the touch coordinate detector 13 and the touch information controllers 14 and 16 perform the accuracy-oriented process. Thus, accuracy can be prioritized over operability, and accuracy when detecting two touch points (i.e., two positions) can be improved. As a result, it is possible to achieve both operability during touch operation and accuracy when detecting a plurality of points or touched positions.

### Second Embodiment

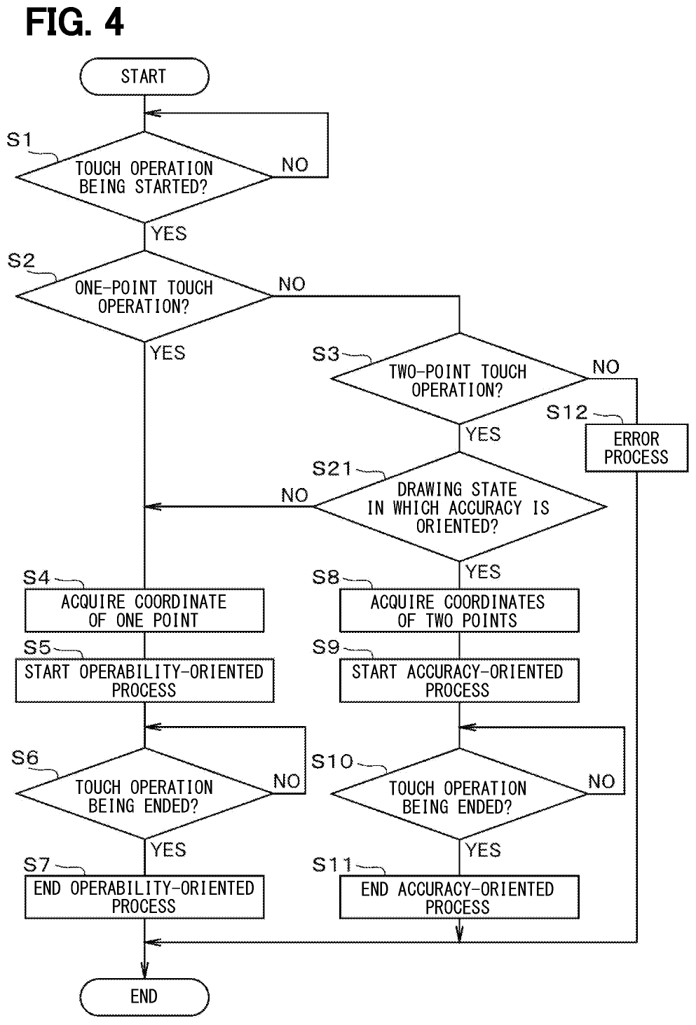

A second embodiment will be described below with reference to FIG. 4. The description of the same portions as those in the first embodiment will be omitted, and differences from the first embodiment will be described. In the second embodiment, it is determined whether or not the screen display is in a drawing state in which accuracy is oriented or emphasized.

Suppose when the external device 3 is connected to the navigation device 2, the touch position detection system 1 may determine the two-point touch operation (S3: YES). In this case, it is determined whether the screen display at that time is in a drawing state in which accuracy is oriented or emphasized (S21). When the touch position detection system 1 determines that the screen display is not in the drawing state in which accuracy is oriented (S21: NO), the touch position detection system 1 acquires the touch coordinate of one point (S4), and performs step S4 and subsequent steps described in the first embodiment. On the other hand, when the touch position detection system 1 determines that the screen display is in a drawing state in which accuracy is oriented (S21: YES), the touch position detection system 1 acquires the touch coordinates of two points (S8), and performs step S8 and subsequent steps described in the first embodiment.

As described above, according to the second embodiment, the one-point touch operation is determined, but if it is determined that the screen display is not in the drawing state in which accuracy is oriented, the touch coordinate detector 13 and the touch information controllers 14 and 16 performs the operability-oriented process. When the two-point touch operation is determined and it is determined that the screen display is in the drawing state in which accuracy is oriented, the touch coordinate detector 13 and the touch information controllers 14 and 16 perform the accuracy-oriented process. It is possible to determine whether to perform the operability-oriented process or the accuracy-oriented process in consideration of whether or not the screen display is in the drawing state in which accuracy is oriented.

### Third Embodiment

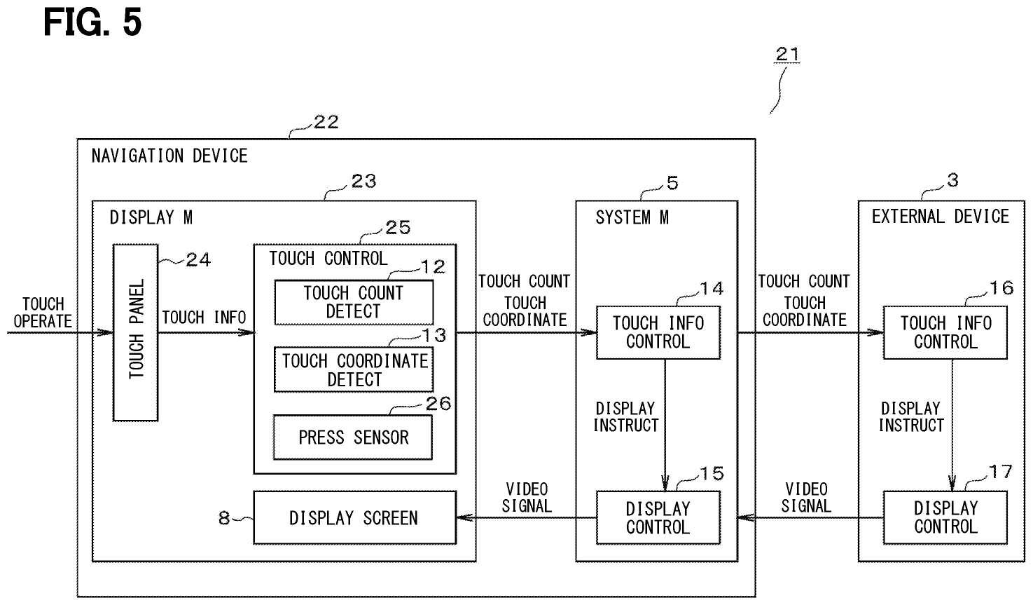

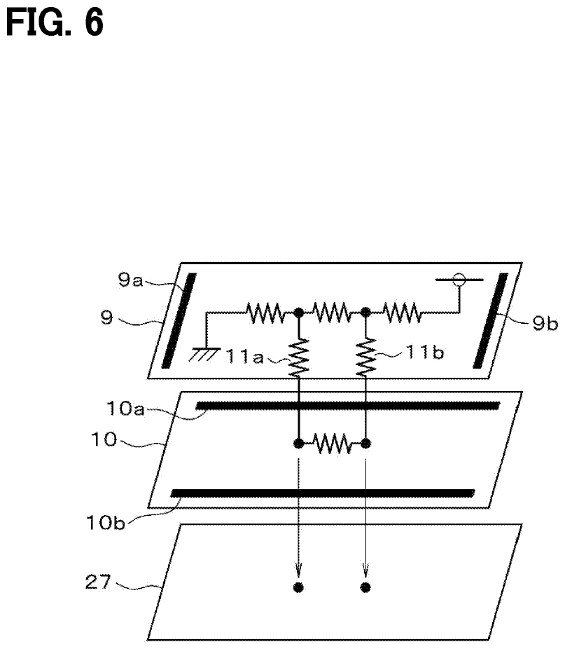

Hereinafter, a third embodiment will be described with reference to FIGS. 5 and 6. The description of the same portions as those in the first embodiment will be omitted, and differences from the first embodiment will be described. In the third embodiment, the pressure applied to the touch panel 6 is detected by the piezoelectric element layer.

In a touch position detection system 21, a navigation device 22 includes a display module 23 (which may also referred to as a display unit 23) and a system module 5 (which may also referred to as a system unit 5). The display module 23 includes a touch panel 24, a touch controller 25 (which may also referred to as a touch controller unit 25), and a display screen 8. The touch controller 25 includes a pressure sensor 26 in addition to the touch count detector 12 and the touch coordinate detector 13.

As shown in FIG. 6, the touch panel 24 includes a piezoelectric element layer 27 in addition to the upper layer 9 and the lower layer 10. The pressure sensor 26 senses or detects the pressure applied to the touch panel 24 by the piezoelectric element layer 27. When the pressure applied to the touch panel 24 is sensed or detected by the pressure sensor 26, the touch coordinate detector 13 detects the coordinate of the touched point on the touch panel 24 as a touch coordinates using the sensing or detection result.

As described above, according to the third embodiment, the same operation and effects as those of the first embodiment can be obtained. Further, the coordinate of the touched point on the touch panel 24 is detected as the touch coordinate by using the sensing result of the pressure sensor 26. By using the sensing result of the pressure sensor 26, the coordinate of the touched position or point can be detected more accurately as the touch coordinate.

### Other Embodiments

Although the present disclosure has been described in accordance with the examples, it is understood that the present disclosure is not limited to such examples or structures. The present disclosure incorporates various modifications and variations within the scope of equivalents. Additionally, various combinations and configurations, as well as other combinations and configurations including more, less, or only a single constituent element, are within the scope and spirit of the present disclosure.

In the above embodiments, when the one-point touch operation is determined, both the touch coordinate detector 13 and the touch information controllers 14 and 16 perform the operability-oriented process. However, either the touch coordinate detector 13 or the touch information controllers 14 and 16 may be configured to perform the operability-oriented process. Further, when the two-point touch operation is determined, both the touch coordinate detector 13 and the touch information controllers 14 and 16 perform the accuracy-oriented process. However, the touch coordinate detector 13 or the touch information controls 14 and 16 may be configured to perform the accuracy-oriented process.

In the above embodiments, several controllers have been described, such as the touch controller 7, the touch information controller 14, the touch information controller 16, the display controller 15, the display controller 17, and the touch controller 25. Such controllers and the method thereof described in the present disclosure may be implemented (i) by (a) a first special-purpose computer provided by configuring a processor and a memory programmed to execute one or more functions embodied by a computer program product, or (ii) by (b) a second special-purpose computer provided by configuring a processor with one or more special-purpose hardware logic circuits, or (iii) any combination of (a) the first special-purpose computer provided by configuring the processor and the memory and (b) the second special-purpose computer provided by configuring the processor with one or more special-purpose hardware logic circuits. The computer program may also be stored in a computer readable non-transitory tangible storage medium as instructions to be executed by a computer.

For reference to further explain features of the present disclosure, the description is added as follows.

For example, a navigation device mounted on a vehicle is provided with a touch panel as an HMI (Human Machine Interface). The touch panel is classified into a capacitance type, a resistance film type, and the like according to a method of detecting a touch operation. In recent years, for example, navigation devices have been required to have the same operability as mobile terminals such as smartphones. There is disclosed a configuration of a resistive touch panel having a multi-touch function for detecting a touch operation touching a plurality of positions simultaneously.

The detection accuracy of the resistive touch panel changes depending on the pressing force on the touch panel; thus, there is an issue that the touched positions of a plurality of points may not be accurately detected. In response to such an issue, some measures may be conceivable to improve the accuracy when detecting a plurality of points or touched positions. That is, an unstable coordinate immediately after touch operation may be excluded from the detection target to lengthen the update time of touch coordinate; a filter may be set to increase the number of moving average steps up to the time when the touch coordinate is output.

The above configurations may improve the accuracy when detecting the plurality of points (i.e., touched positions). However, by lengthening the update time of the touch coordinate or increasing the number of moving average steps up to the time when the touch coordinate is output, the operability may be lost such that the screen display does not immediately follow the touch operation.

It is thus desired to achieve both operability during touch operation and accuracy when detecting a plurality of touched positions.

An aspect of the present disclosure described herein is set forth in the following clauses.

According to an aspect of the present disclosure, a touch position detection system is provided to include a touch controller and a touch information controller, and a display controller. The touch controller includes (i) a touch count detector configured to detect a counted number of a touched position by a touch operation on a touch panel as a touch count, and (ii) a touch coordinate detector configured to detect a coordinate of the touched position by the touch operation on the touch panel as a touch coordinate. The touch information controller is configured to control touch information based on a detection result of the touch count detector and a detection result of the touch coordinate detector. The display controller is configured to control a displayed screen image according to a display instruction from the touch information controller.

Herein, in response to determining a one-point touch operation that is the touch operation touching one position on the touch panel, the touch coordinate detector, or the touch information controller, or both the touch coordinate detector and the touch information controller are configured to perform an operability-oriented process. In response to determining a plurality-of-points touch operation that is the touch operation touching a plurality of positions on the touch panel, the touch coordinate detector, or the touch information controller, or both the touch coordinate detector and the touch information controller are configured to perform an accuracy-oriented process.

When the touch operation touching one position is determined, at least one of the touch coordinate detector and the touch information controller performs the operability-oriented process. As a result, operability can be prioritized over accuracy, and operability during touch operation can be improved. On the other hand, when a touch operation touching a plurality of positions is determined, at least one of the touch coordinate detector and the touch information controller performs the accuracy-oriented process. As a result, accuracy can be prioritized over operability, and accuracy when detecting touch positions at a plurality of positions can be improved. As a result, it is possible to achieve both operability during touch operation and accuracy when detecting a plurality of positions.

What is claimed is:

1. A touch position detection system, comprising:
a touch controller including (i) a touch count detector configured to detect a counted number of a touched position by a touch operation on a touch panel as a touch count, and (ii) a touch coordinate detector configured to detect a coordinate of the touched position by the touch operation on the touch panel as a touch coordinate;
a touch information controller configured to control touch information based on a detection result of the touch count detector and a detection result of the touch coordinate detector; and
a display controller configured to control a displayed screen image according to a display instruction from the touch information controller,
wherein:
in response to determining a one-point touch operation that is the touch operation touching one position on the touch panel, (i) the touch coordinate detector, or (ii) the touch information controller, or (iii) both the touch coordinate detector and the touch information controller are configured to perform an operability-oriented process; and
in response to determining a plurality-of-points touch operation that is the touch operation touching a plurality of positions on the touch panel, (i) the touch coordinate detector, or (ii) the touch information controller, or (iii) both the touch coordinate detector and the touch information controller are configured to perform an accuracy-oriented process.

2. The touch position detection system according to claim 1, wherein:
in response to determining the plurality-of-points touch operation but determining the displayed screen image being not under a drawing state in which accuracy is oriented, (i) the touch coordinate detector, or (ii) the touch information controller, or (iii) both the touch coordinate detector and the touch information controller are configured to perform the operability-oriented process; and
in response to determining the plurality-of-points touch operation and determining the displayed screen image being the drawing state in which accuracy is oriented, (i) the touch coordinate detector, or (ii) the touch information controller, or (iii) both the touch coordinate detector and the touch information controller are configured to perform the accuracy-oriented process.

3. The touch position detection system according to claim 1, further comprising:
a pressure sensor configured to sense a pressure applied to the touch panel with a piezoelectric element layer,
wherein:
the touch coordinate detector is configured to detect the coordinate of the touched position on the touch panel as the touch coordinate using a sensing result of the pressure sensor.

4. The touch position detection system according to claim 1, wherein:
in performing the operability-oriented process, the touch coordinate detector is configured to perform a process that relatively shortens an update time of the touch coordinate without excluding an unstable coordinate immediately after the touch operation from a detection target; and
in performing the accuracy-oriented process, the touch coordinate detector is configured to perform a process that relatively lengthens the update time of the touch coordinate by excluding the unstable coordinate immediately after the touch operation from the detection target.

5. The touch position detection system according to claim 1, wherein:
in performing the operability-oriented process, the touch information controller is configured to perform a process that relatively decreases a counted number of moving average steps up to when the touch coordinate is output by releasing a filter; and
in performing the accuracy-oriented process, the touch information controller is configured to perform a process that relatively increases the counted number of moving average steps up to when the touch coordinate is output by setting the filter.

6. The touch position detection system according to claim 1, further comprising:
an in-vehicle device including the touch count detector, the touch coordinate detector, the touch information controller, and the display controller.

7. The touch position detection system according to claim 1, further comprising:
an in-vehicle device; and
an external device configured to perform a data communication with the in-vehicle device,
wherein:
the in-vehicle device includes the touch count detector, the touch coordinate detector, and the touch information controller; and
the external device includes the display controller.

8. A touch position detection system, comprising:
at least one first processor configured to
detect a counted number of a touched position by a touch operation on a touch panel as a touch count, and
detect a coordinate of the touched position by the touch operation on the touch panel as a touch coordinate;
at least one second processor configured to
control touch information based on a detection result by the at least one first processor; and
at least one third processor configured to control a displayed screen image according to a display instruction from the at least one second processor,
wherein:
in response to determining a one-point touch operation that is the touch operation touching one position on the touch panel, (i) the at least one first processor, or (ii) the at least one second processor, or (iii) both the at least one first processor and the at least one second processor are configured to perform an operability-oriented process; and
in response to determining a plurality-of-points touch operation that is the touch operation touching a plurality of positions on the touch panel, (i) the at least one first processor, or (ii) the at least one second processor, or (iii) both the at least one first processor and the at least one second processor are configured to perform an accuracy-oriented process.

9. The touch position detection system according to claim 8, wherein:
in response to determining the plurality-of-points touch operation but determining the displayed screen image being not under a drawing state in which accuracy is oriented, (i) the at least one first processor, or (ii) the at least one second processor, or (iii) both the at least one first processor and the at least one second processor are configured to perform the operability-oriented process; and
in response to determining the plurality-of-points touch operation and determining the displayed screen image being the drawing state in which accuracy is oriented, (i) the at least one first processor, or (ii) the at least one second processor, or (iii) both the at least one first processor and the at least one second processor are configured to perform the accuracy-oriented process.

10. The touch position detection system according to claim 8, further comprising:
a pressure sensor configured to sense a pressure applied to the touch panel with a piezoelectric element layer,
wherein:
the at least one first processor is configured to detect the coordinate of the touched position on the touch panel as the touch coordinate using a sensing result of the pressure sensor.

11. The touch position detection system according to claim 8, wherein:
in performing the operability-oriented process, the at least one first processor is configured to perform a process that relatively shortens an update time of the touch coordinate without excluding an unstable coordinate immediately after the touch operation from a detection target; and
in performing the accuracy-oriented process, the at least one first processor is configured to perform a process that relatively lengthens the update time of the touch coordinate by excluding the unstable coordinate immediately after the touch operation from the detection target.

12. The touch position detection system according to claim 8, wherein:
in performing the operability-oriented process, the at least one second processor is configured to perform a process that relatively decreases a counted number of moving average steps up to when the touch coordinate is output by releasing a filter; and
in performing the accuracy-oriented process, the at least one second processor is configured to perform a process that relatively increases the counted number of moving average steps up to when the touch coordinate is output by setting the filter.

13. The touch position detection system according to claim 8, further comprising: an in-vehicle device including the at least one first processor, the at least one second processor, and the at least one third processor.

14. The touch position detection system according to claim 8, further comprising: an in-vehicle device; and
an external device configured to perform a data communication with the in-vehicle device,
wherein:
the in-vehicle device includes the at least one first processor and the at least one second processor: and
the external device includes the at least one third processor.
